(19) United States
(12) Patent Application Publication
(10) Pub. No.: US 2021/0091356 A1
(43) Pub. Date: Mar. 25, 2021

(54) MANUFACTURING METHOD OF FUEL CELL

(71) Applicant: TOYOTA JIDOSHA KABUSHIKI KAISHA, Toyota-shi (JP)

(72) Inventors: Hideo NAKAMURA, Susono-shi (JP); Takuya HATTORI, Shizuoka-ken (JP)

(21) Appl. No.: 16/944,297

(22) Filed: Jul. 31, 2020

(30) Foreign Application Priority Data
Sep. 24, 2019 (JP) 2019-172761

(51) Int. Cl. H01M 2/14; H01M 8/04029; H01M 8/0254; B23K 26/21; B23K 37/04

(52) U.S. Cl. CPC H01M 2/145; H01M 8/04029; B23K 2101/36; B23K 26/21; B23K 37/0443; H01M 8/0254

(57) ABSTRACT

A manufacturing method of a fuel cell includes a welding step in which a plurality of protrusions of each of a pair of separators is welded with the protrusions overlapping each other such that laser welding is intermittently performed on a plurality of welding positions by repeating one laser irradiation operation by a predetermined length. Each of the separators has, on a surface facing a membrane-electrode-gas diffusion layer assembly, the protrusions such that the surface is corrugated in a surface direction.

The disclosure of Japanese Patent Application No. 2019-172761 filed on Sep. 24, 2019 including the specification, drawings and abstract is incorporated herein by reference in its entirety.

### BACKGROUND

### 1. Technical Field

The disclosure relates to a manufacturing method of a fuel cell.

### 2. Description of Related Art

As a fuel cell, there is known a fuel cell including a pair of separators and a membrane-electrode-gas diffusion layer assembly (MEGA).

### SUMMARY

To reduce electrical resistance between the separators, for example, it is conceivable to perform a surface treatment on the separators to reduce contact resistance. However, in general, the surface treatment is a complicated process and increases the manufacturing cost. In view of this, the inventors of the disclosure have made studies on performing laser welding on a region facing the MEGA and in which the separators overlap each other as described in Japanese Unexamined Patent Application Publication No. 2009-99258 (JP 2009-99258 A). However, when the laser is linearly scanned at the welding position, welding pools around keyholes are disordered at the starting point and ending point of welding, and irregularities are generated in the weld bead.

The disclosure provides a manufacturing method of a fuel cell.

A manufacturing method of a fuel cell according to a first aspect of the disclosure includes a welding step in which a plurality of protrusions of each of a pair of separators is welded with the protrusions overlapping each other such that laser welding is intermittently performed on a plurality of welding positions, wherein the laser welding is performed on each of the welding positions by one laser irradiation operation by a predetermined length. Each of the separators has, on a surface facing a membrane-electrode-gas diffusion layer assembly, the protrusions such that the surface is corrugated in a surface direction.

According to the first aspect of the disclosure, the separators are intermittently laser-welded by repeating one laser irradiation operation by a predetermined length. It is thus possible to suppress the molten pool from being disordered, and to suppress the occurrence of irregularities in the weld bead compared to the case in which the welding positions are welded while scanning the laser.

The first aspect may include a pressing step in which, prior to the welding step, the pair of separators is pressed with the pair of separators overlapping each other. According to the above configuration, welding is performed after the pair of separators are overlapped and pressed and the gap between the separators is reduced. Therefore, welding failures can be more effectively suppressed, and the occurrence of irregularities in the weld bead can be suppressed.

In the above aspect, in the pressing step, the pair of separators may be pressed using a pressing jig.

In the above aspect, the pressing jig may have openings for welding at positions corresponding to the welding positions in the welding step. Laser welding may be performed through the openings with the pair of separators pressed by the pressing jig.

According to the above configuration, laser welding can be performed with reduced gap between the pair of separators by pressing the pair of separators with the pressing jig, so that the thickness of the fuel cell can be suppressed from being varied.

In the above aspect, in the pressing step, a punching process may be performed on the welding positions through the openings. According to the above configuration, since punching is performed at the welding positions, the gap between the separators at the welding positions can be more effectively reduced, and the thickness of the fuel cell can be suppressed from being varied.

In the above aspect, the pair of separators may be disposed so as to define between the separators flow paths through which a coolant flows. In the welding step, a welding length per laser irradiation operation in a direction in which the flow paths extend may be longer than a width of the protrusions in the direction perpendicular to the direction in which the flow paths extend.

According to the above configuration, in the welding step, the welding length in the direction in which the flow paths extend is longer than the width of the protrusions in the direction perpendicular to the direction in which the flow paths extend. Thus, the contact resistance between the pair of separators can be reduced with a small number of welding positions.

In the above aspect, each of the separators may have, on the surface facing the membrane-electrode-gas diffusion layer assembly, recesses such that the surface is corrugated in the surface direction. The predetermined length may be a length that allows at least a part of the protrusions of one of the separators and a corresponding part of the protrusions of the other of the separators to overlap each other and does not allow the protrusions of one of the separators to fit into the recesses of the other of the separators.

In the above aspect, the fuel cell may have the pair of separators and the membrane-electrode-gas diffusion layer assembly adjacent to the pair of separators. By performing the laser welding, flow paths through which a coolant flows may be formed between the pair of separators.

The disclosure can be implemented in various modes, for example, in a mode of a fuel cell manufactured by the manufacturing method of the above-described mode, and a fuel cell stack including the fuel cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram of a fuel cell;

FIG. 2 is a schematic sectional view taken along a line II-II in FIG. 1;

FIG. 3 is a process chart showing an example of a manufacturing method of the fuel cell;

FIG. 4 is an explanatory diagram showing a welding process;

FIG. 5 is an explanatory diagram showing a welding length in the welding process;

FIG. 6 is a process chart showing an example of a manufacturing method of the fuel cell according to a second embodiment;

FIG. 7 is an explanatory diagram of a pressing jig;

FIG. 8 is another explanatory diagram of the pressing jig; and

FIG. 9 is an explanatory diagram of a pressing process of separators according to a third embodiment.

### DETAILED DESCRIPTION OF EMBODIMENTS

### A. First Embodiment

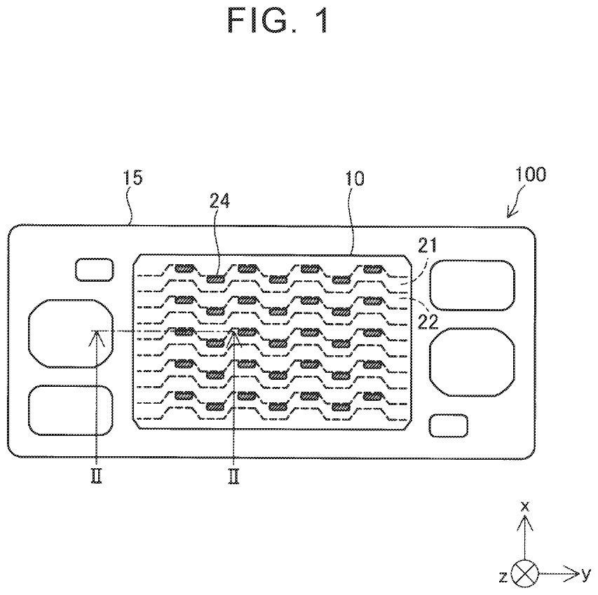

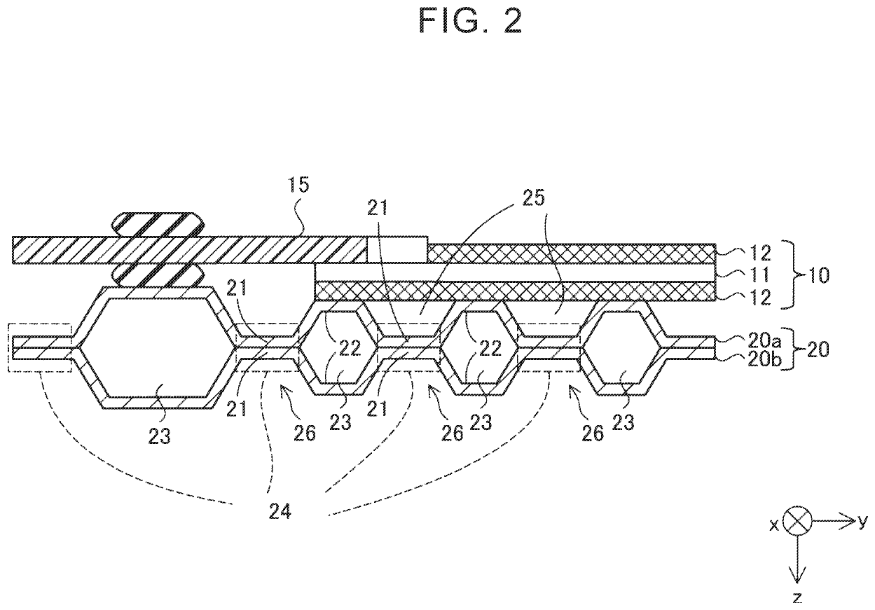

FIG. 1 is an explanatory diagram of a fuel cell 100 manufactured by a manufacturing method according to a first embodiment of the present disclosure. FIG. 2 is a schematic sectional view taken along a line II-II in FIG. 1. FIG. 1 shows an x-axis, a y-axis, and a z-axis that are orthogonal to each other. The x-axis indicates a direction along the short length of the fuel cell 100, the y-axis indicates a direction along the long length of the fuel cell 100, and the z-axis indicates a direction in the stacking direction of the fuel cell 100. These axes correspond to the axes shown in FIG. 2 and figures thereafter.

The fuel cell 100 is a polymer electrolyte fuel cell that generates power by receiving hydrogen and oxygen as reaction gas. As shown in FIG. 2, the fuel cell 100 includes a membrane-electrode-gas diffusion layer assembly 10 and a pair of separators 20a, 20b. The membrane-electrode-gas diffusion layer assembly 10 includes a membrane electrode assembly (MEA) 11 and gas diffusion layers 12. A resin sheet 15 is connected to the membrane-electrode-gas diffusion layer assembly 10 so as to surround the membrane-electrode-gas diffusion layer assembly 10.

The membrane electrode assembly 11 includes an electrolyte membrane and catalyst layers formed adjacent to opposite surfaces of the electrolyte membrane. The electrolyte membrane is a solid polymer thin film showing good proton conductivity in a wet state. The electrolyte membrane is composed of, for example, an ion exchange membrane composed of a fluororesin. Each of the catalyst layers includes a catalyst for promoting a chemical reaction between hydrogen and oxygen, and carbon particles carrying the catalyst.

The gas diffusion layers 12 are provided adjacent to the membrane electrode assembly 11 on its catalyst layer sides. The gas diffusion layers 12 are layers for diffusing the reaction gas used for the electrode reaction along the surface direction of the electrolyte membrane, and is composed of a porous diffusion layer base material. As the diffusion layer base material, a porous base material having electric conductivity and gas diffusibility is used, such as a carbon fiber base material, a graphite fiber base material, and a foamed metal.

The pair of separators 20a, 20b is disposed adjacent to the membrane-electrode-gas diffusion layer assembly 10. In the present embodiment, the separator 20a is disposed adjacent to the membrane-electrode-gas diffusion layer assembly 10, and the separator 20b is disposed adjacent to the separator 20a. This constitutes a set of the membrane-electrode-gas diffusion layer assembly 10, the separator 20a, and the separator 20b being arranged in this order. A plurality of sets thereof are stacked to constitute a fuel cell stack. Only one separator is disposed at each end of the fuel cell stack.

The separators 20a, 20b are formed, for example, by press-working a metal plate made of stainless steel, titanium, or an alloy thereof into a corrugated shape. Each of the separators 20a, 20b has, on their surfaces facing each other, a plurality of protrusions 21 and recesses 22 such that the surfaces are corrugated in a surface direction. In the present embodiment, the separators 20a, 20b have the protrusions 21 and the recesses 22 on both surfaces. However, the separators 20a, 20b may have the protrusions 21 and the recesses 22 only on one surface. “The surfaces are corrugated in the surface direction” means that, in the present embodiment, corrugations with a predetermined period are provided in the surface direction. As shown in FIG. 1, the protrusions 21 and the recesses 22 extend along the y-axis direction and are alternately arranged in the x-axis direction. Hereinafter, the separators 20a and the separators 20b are collectively referred to as the separators 20.

Flow paths 23 are defined between the pair of separators 20 facing the membrane-electrode-gas diffusion layer assembly 10. More specifically, the separator 20a and the separator 20b are welded at a plurality of welding portions 24 with the protrusions 21 of the separator 20a and the protrusions 21 of the separator 20b adjacent to each other, thereby defining wave-shaped flow paths 23 between the separators 20. In the present embodiment, the separator 20a and the separator 20b are welded such that the protrusions 21 of the separator 20a and the protrusions 21 of the separator 20b face each other and abut against each other. The welding portions 24 are positions where the protrusions 21 of the separator 20a and the protrusions 21 of the separator 20b overlap each other when the separators 20 are viewed along the z-axis direction.

The flow paths 23 are flow paths through which a coolant flows. Gas flow paths 25, 26 through which the reaction gas flows are defined between the gas diffusion layers 12 and the separators 20. The reaction gas flowing through the gas flow paths 25, 26 reacts in the membrane-electrode-gas diffusion layer assembly 10 to cause an electrode reaction.

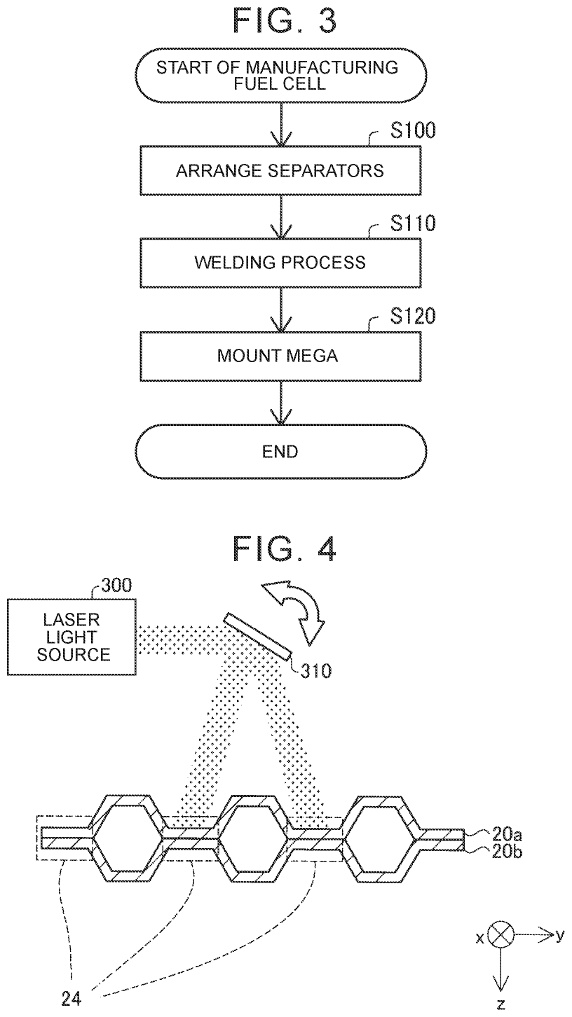

FIG. 3 is a process chart showing an example of the manufacturing method of the fuel cell 100 according to the present embodiment. In the manufacture of the fuel cell 100 according to the present embodiment, first, in step S100, the pair of separators 20 are arranged. More specifically, the pair of separators 20a, 20b having, on their surfaces facing the membrane-electrode-gas diffusion layer assembly 10, the protrusions 21 such that the surfaces are corrugated in the surface direction are prepared. The pair of separators 20a, 20b are arranged so as to overlap each other and such that the protrusions 21 of the separator 20a and the protrusions 21 of the separator 20b are adjacent to each other to define the flow paths 23.

Next, in step S110, welding is performed on the welding portions 24. More specifically, laser welding is intermittently performed at the welding positions on the protrusions 21 of the pair of the separators 20. In the present embodiment, welding is performed on the separator 20a side. However, the present disclosure is not limited to this, and welding may be performed on the separator 20b side or welding may be performed from both sides.

FIG. 4 is an explanatory diagram showing a welding process. In the present embodiment, the separators 20 are intermittently welded on a plurality of positions by a predetermined length by one shot, while changing the irradiation position of a linear laser light emitted from a laser light source 300 in the x-axis direction or the y-axis direction with a Galvano scanner 310. That is, in the present embodiment, rather than performing spot welding having a round welding shape successively by a predetermined length, a shape having a predetermined length is welded by one laser irradiation operation by beam forming. Hereinafter, such welding is also referred to as “one-shot laser welding”. The laser welding is, for example, heat conductive welding performed by irradiating a laser beam at 3.5 kW for 1.4 msec per welding portion 24.

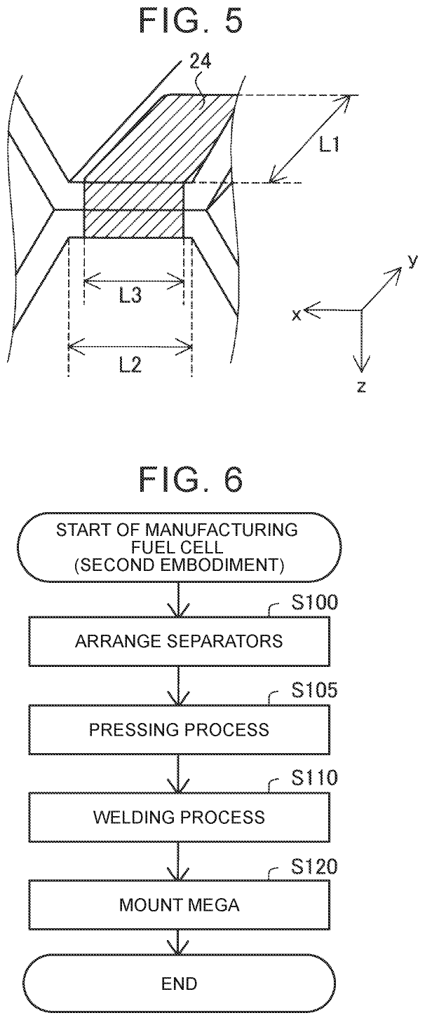

FIG. 5 is an explanatory diagram showing a welding length in the welding process. A predetermined welding length L1 is a length that allows a deviation in the welding process. The length that allows the deviation is specifically a length that allows, when the separators 20a, 20b overlap each other, at least a part of the protrusions 21 of one of the separators 20a, 20b and a corresponding part of the protrusions 21 of the other of the separators 20a, 20b to overlap each other and does not allow the protrusions 21 of one of the separators 20a, 20b to fit into the recesses 22 of the other of the separators 20a, 20b. The length L1 is, for example, approximately 2 mm. In the present embodiment, the welding is performed so that the welding length L1 per welding operation in the direction in which the flow paths 23 extend (y-axis direction) is longer than a width L2 of the protrusions 21 in the direction perpendicular to the direction in which the flow paths 23 extend (x-axis direction). The “width of the protrusions 21” indicates the inner width of the portion where tip surfaces of the protrusions 21 overlap each other. A length L3 of the welding width in the direction perpendicular to the direction in which the flow paths 23 extend (x-axis direction) is shorter than the width L2, and is, for example, 0.1 mm.

Finally, in step S120 (FIG. 3), the membrane-electrode-gas diffusion layer assembly 10 is mounted on the separators 20 that have been welded in step S110. More specifically, the resin sheet 15 connected to the membrane-electrode-gas diffusion layer assembly 10 so as to surround the membrane-electrode-gas diffusion layer assembly 10 is thermally bonded to the separators 20 via a bonding resin.

According to the fuel cell manufacturing method of the present embodiment described above, the separators 20 are welded by laser welding is performed on each of welding positions by one laser irradiation operation by a predetermined length. It is thus possible to suppress a molten pool from being disordered as compared to welding the welding positions while scanning the laser beam, and it is also possible to suppress the occurrence of irregularities in the weld bead. Further, even when there is a gap between the separators 20, since the heat conductive laser welding is performed and the volume of the molten pool increases, the surfaces of the separators 20 to be welded and the molten pool are connected by droplets. It is thus possible to suppress the occurrence of unevenness in the weld bead. As a result, it is possible to suppress the flow of the reaction gas in the gas flow paths 25, 26 from being hindered due to the unevenness in the welding portions 24.

The welding length L1 in the direction in which the flow paths 23 extend is longer than the width L2 of the protrusions 21 in the direction perpendicular to the direction in which the flow paths 23 extend, that is, the width L2 of the flow paths 23. Thus, the contact resistance between the pair of separators 20 can be reduced with a small number of welding positions. In the present embodiment, the welding length L1 is longer than the width L2 of the protrusions 21, but the dimensions can be changed depending on the contact resistance conditions required between the separators 20. For example, the shape of the welding positions may be a circle or an ellipse.

### B. Second Embodiment

FIG. 6 is a process chart showing an example of a manufacturing method of a fuel cell according to a second embodiment. The manufacturing method of the fuel cell according to the second embodiment differs from the manufacturing method of the fuel cell according to the first embodiment in that a pressing process of pressing the separators 20 with the separators 20 overlapping each other is performed after step S100 (FIG. 3), that is, prior to the welding process in step S110. The other processes are the same as those in the first embodiment. The configuration of the fuel cell according to the second embodiment is the same as the configuration of the fuel cell according to the first embodiment, so description of the configuration of the fuel cell is omitted.

In the second embodiment, in step S105 (FIG. 6), a pressing process of pressing the pair of separators 20 overlapped in step S100 is performed. More specifically, for example, the pair of separators 20 are overlapped and pressed using a pressing jig to reduce the gap between the protrusions 21 of the separator 20a and the protrusions 21 of the separator 20b.

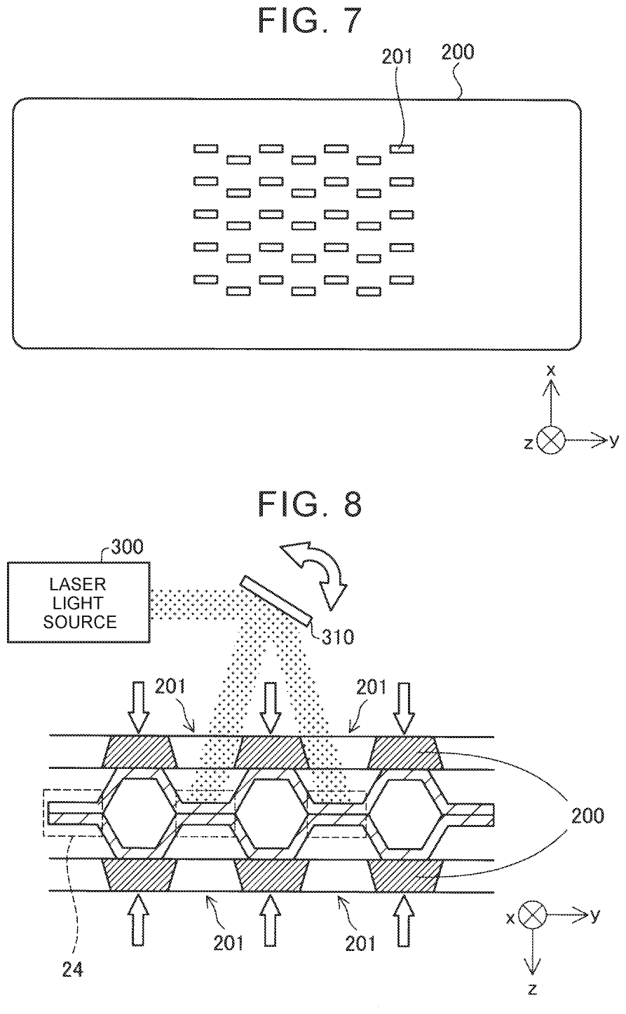

FIG. 7 and FIG. 8 are explanatory diagrams of the pressing jig 200 in the present embodiment. As shown in FIG. 7, the pressing jig 200 has openings 201 for welding at positions corresponding to the welding portions 24 that is the welding positions of the separator 20. As shown in FIG. 8, in the second embodiment, in the welding process in step S110 (FIG. 6), welding is performed by laser irradiation through the openings 201 with the separators 20 pressed against each other by the pressing jig 200.

According to the manufacturing method of the fuel cell of the present embodiment described above, prior to the welding process, the separators 20 are overlapped and pressed against each other to reduce the gap between the separators 20. Accordingly, welding failures can be more effectively suppressed, and the occurrence of irregularities in the weld bead can be suppressed. In addition, welding can be performed through the openings 201 with the separators 20 pressed against each other by the pressing jig 200. Therefore, the one-shot laser welding can be performed with reduced gap between the pair of separators 20, and thus the thickness of the fuel cell can be suppressed from being varied.

### C. Third Embodiment

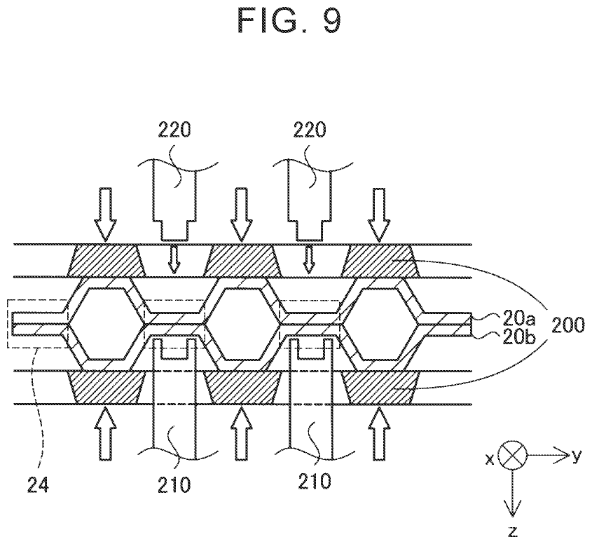

FIG. 9 is an explanatory diagram of a pressing process of the separators 20 according to a third embodiment. A manufacturing method of a fuel cell according to the third embodiment differs from the manufacturing method of the fuel cell according to the second embodiment in that a punching process is performed on the welding positions through the openings 201 of the pressing jig 200 in the pressing process in step S105 (FIG. 6). The other processes are the same as those in the second embodiment. The configuration of the fuel cell according to the third embodiment is the same as the configuration of the fuel cell according to the first embodiment, so description of the configuration of the fuel cell is omitted.

### Punching Process

In the third embodiment, in step S105, the welding portions 24 are pressed with a punch through the openings 201 while pressure is applied to the separators 20 by the pressing jig 200. In the present embodiment, as shown in FIG. 9, receiving members 210 having recessed portions are disposed on the separator 20b side, and then punch members 220 having protruding portions are pressed on the separator 20a side to simultaneously apply pressure to all of the welding portions 24. The punching process is not limited to being performed simultaneously, and may be performed for each of the one or more welding portions 24. After performing the punching process, the punched portions are laser-welded in step S110.

According to the manufacturing method of the fuel cell of the present embodiment described above, the punching process is performed on the welding portions 24 through the openings 201 of the pressing jig 200 in the pressing process, so that the gap between the pair of separators 20 can be reduced more effectively. Therefore, it is possible to suppress the thickness of the fuel cell from being varied.

### D. Other Embodiments

In the above embodiments, in the one-shot laser welding in step S110 (FIG. 3), the welding positions are intermittently welded using the Galvano scanner 310. Alternatively, the laser light source 300 may directly irradiate the welding positions, and may be moved to intermittently weld the welding positions.

In the above embodiments, in the one-shot laser welding in step S110 (FIG. 6), welding is performed while applying pressure using the pressing jig 200 provided with the openings 201. Alternatively, the pressing process may be performed using the pressing jig 200 provided with no openings 201. In this case, the welding process may be performed after removing the pressing jig 200.

The present disclosure is not limited to the embodiments described above, and can be implemented in various configurations without departing from the spirit thereof. For example, the technical features in the embodiments corresponding to the technical features in the aspects described in the SUMMARY may be appropriately replaced or combined in order to solve the above-described issues, or in order to achieve some or all of the effects described above. Unless described as essential in the present specification, the technical features may be deleted as appropriate.

What is claimed is:

1. A manufacturing method of a fuel cell, the manufacturing method comprising a welding step in which a plurality of protrusions of each of a pair of separators is welded with the protrusions overlapping each other such that laser welding is intermittently performed on a plurality of welding positions, each of the separators having, on a surface facing a membrane-electrode-gas diffusion layer assembly, the protrusions such that the surface is corrugated in a surface direction, wherein the laser welding is performed on each of the welding positions by one laser irradiation operation by a predetermined length.

2. The manufacturing method of a fuel cell according to claim 1, further comprising a pressing step in which, prior to the welding step, the pair of separators is pressed with the pair of separators overlapping each other.

3. The manufacturing method of a fuel cell according to claim 2, wherein in the pressing step, the pair of separators is pressed using a pressing jig.

4. The manufacturing method of a fuel cell according to claim 3, wherein:
the pressing jig has openings for welding at positions corresponding to the welding positions in the welding step; and
laser welding is performed through the openings with the pair of separators pressed by the pressing jig.

5. The manufacturing method of a fuel cell according to claim 4, wherein in the pressing step, a punching process is performed on the welding positions through the openings.

6. The manufacturing method of a fuel cell according to claim 1, wherein:
the pair of separators is disposed so as to define between the separators, flow paths through which a coolant flows; and
in the welding step, a welding length per laser irradiation operation in a direction in which the flow paths extend is longer than a width of the protrusions in the direction perpendicular to the direction in which the flow paths extend.

7. The manufacturing method of a fuel cell according to claim 1, wherein:
each of the separators has, on the surface facing the membrane-electrode-gas diffusion layer assembly, recesses such that the surface is corrugated in the surface direction; and
the predetermined length is a length that allows at least a part of the protrusions of one of the separators and a corresponding part of the protrusions of the other of the separators to overlap each other and does not allow the protrusions of one of the separators to fit into the recesses of the other of the separators.

8. The manufacturing method of a fuel cell according to claim 1, wherein:
the fuel cell has the pair of separators and the membrane-electrode-gas diffusion layer assembly adjacent to the pair of separators; and
by performing the laser welding, flow paths through which a coolant flows are formed between the pair of separators.
